(19) United States
(12) Patent Application Publication
(10) Pub. No.: US 2009/0180851 A1
(43) Pub. Date: Jul. 16, 2009

(54) DEVICE FOR HANDLING CARS IN MULTISTOREY CAR PARKS WITH IMPROVED RAISING SYSTEM

(75) Inventor: Carlo Manzotti, Arconate (IT)

Correspondence Address: YOUNG & THOMPSON, 209 Madison Street, Suite 500, ALEXANDRIA, VA, 22314, US

(73) Assignees: Carlo MANZOTTI, Arconate (IT); PROVIRON TECHNOLOGY B.V. ,rotterdam, Lugano (CH)

(21) Appl. No.: 12/299,995

(22) PCT Filed: May 3, 2007
(86) PCT No.: PCT/IB2007/001144

§ 371 Date: Nov. 7, 2008

(30) Foreign Application Priority Data
May 9, 2006 (IT) MI2006A000911

(51) Int. Cl. B65G 67/02; F16H 35/06

(52) U.S. Cl. 414/350; 74/380

(57) ABSTRACT

A device for handling cars (100) in multistorey car parks is described. The device includes a front carriage (1) able to be positioned opposite the front wheels (101) of the car so as to raise them and a rear carriage (2) able to be positioned opposite the rear wheels (102) of the car so as to raise them, in such a way as to be able to move the car (100). Each carriage (1, 2) has a main frame (14) supporting gripping members (15) able to support the wheels (101, 102) of the car and a secondary frame (16) which is pivotably mounted, along a transverse axis, on the main frame (14). The secondary frame (16) is joined to the main frame (14) in a compass-joint relationship by respective pinions (20) and gearwheels (21) which are rotationally actuated by elements of a drive (17) so as to obtain raising/lowering of the main frame (14).

The present invention relates to a device for handling cars in multistorey car parks, provided with a system for raising the wheels of the car.

As is known, a multistorey car park with an automatic parking system comprises a plurality of parking areas which below will be referred to as “bays” arranged on several levels.

In order to move and support the cars, a handling mechanism is provided, said mechanism comprising a gantry crane or displacement/elevator device which can be displaced horizontally along the corridors existing between the various rows of bays and is provided with a platform which can be raised so as to position the cars at the height of the various levels.

The platform is provided with special handling systems able to remove the car from the platform and position it inside the bay and vice versa. These handling systems, according to the prior art, normally envisage the so-called “comb” system comprising a carriage with comb-like ends able to slide inside corresponding sawtooth slits formed in the platform and on the floor of each bay.

Also known are handling systems comprising a pair of carriages which raise the front and rear wheels of the vehicle, respectively, in order to transport it into the bay such as that described in the PCT patent application WO95/03462 in the name of the same applicant. The carriage comprises a fixed frame which rotatably supports the wheels of the carriage. The fixed frame has, mounted thereon, a movable frame supporting the means for gripping the wheels of the car. The movable frame is rigidly connected to a rack mounted slidably in a vertical direction in the fixed frame of the carriage. The rack is moved vertically, so as to raise/lower the movable frame, by means of a gearwheel which is rotationally actuated by an electric motor.

This raising system has drawbacks due to the excessive power of the motor, the wear of the gears, the constructional complexity and the excessive height of the carriage due to the two frames arranged on top of each other. The problem of the height of the carriage is particularly evident above all in the case of sports cars which have chassis very close to the ground and which could interfere with the movable frame of the carriage even when it is in a lowered position.

The object of the invention is to eliminate the drawbacks of the prior art by providing a device for handling cars in multistorey car parks, provided with a system for raising the car which is reliable, versatile, low-cost, compact and easy to manufacture.

This object is achieved according to the invention with the characteristic features which are listed in the accompanying independent Claim 1. Preferred embodiments of the invention are described in the dependent claims.

The device for transferring cars in multistorey car parks according to the invention comprises a front carriage able to be positioned opposite the front wheels of the car so as to raise them and a rear carriage able to be positioned opposite the rear wheels of the car so as to raise them, in such a way as to be able to move the car. Each carriage comprises a main frame supporting gripping means able to support the wheels of the vehicle.

At least one of said carriages comprises a secondary frame which is pivotably mounted, along a transverse axis, on said main frame.

The secondary frame is joined to the main frame in a compass-joint relationship by means of respective pinions and gearwheels which mesh with each other and which are rotationally actuated by means of a drive system so as to obtain raising/lowering of the main frame.

The advantages of the carriage according to the invention provided with a compass raising system are evident. In fact the compass raising system allows the use of a larger reduction ratio compared to the known rack systems. As a result it is possible to use a less powerful motor and there is less wear of the gears.

Moreover, the compass raising system allows the use of two frames, movable opposite each other, unlike the known systems which envisage a movable frame arranged above the fixed frame. As a result it is possible to obtain a considerable reduction in the height of the carriage according to the invention which may also be used for sports cars which have a very low chassis.

Further characteristic features of the invention will become clearer from the detailed description which follows, with reference to a purely exemplary and therefore non-limiting embodiment thereof, illustrated in the accompanying drawings, in which:

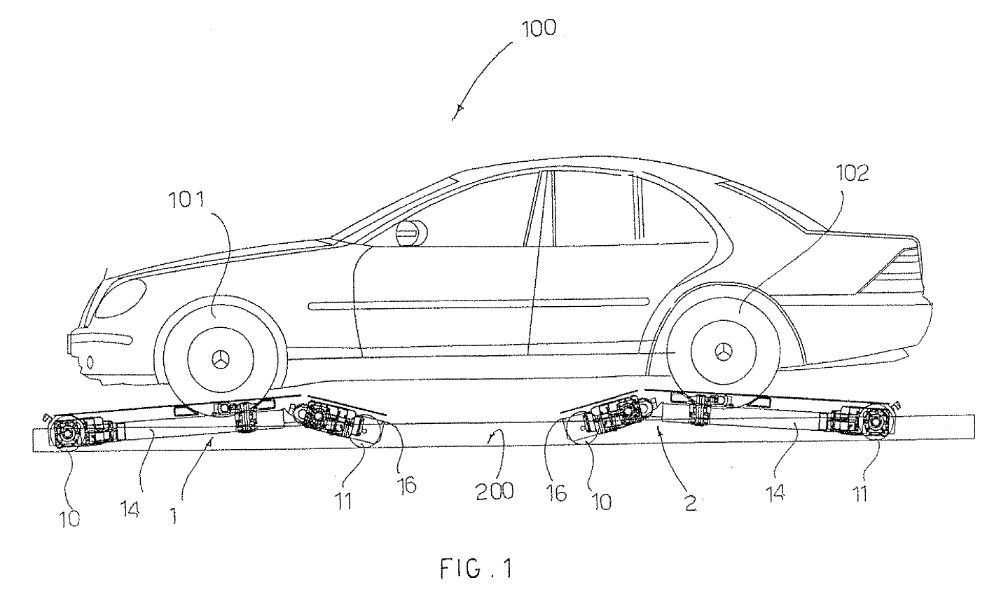

FIG. 1 is a side elevation view showing a car positioned on two carriages which form the handling device according to the invention, in which the carriages are arranged on a platform of a entry/exit area of a multistorey car park and are in the position for raising the wheels of the car;

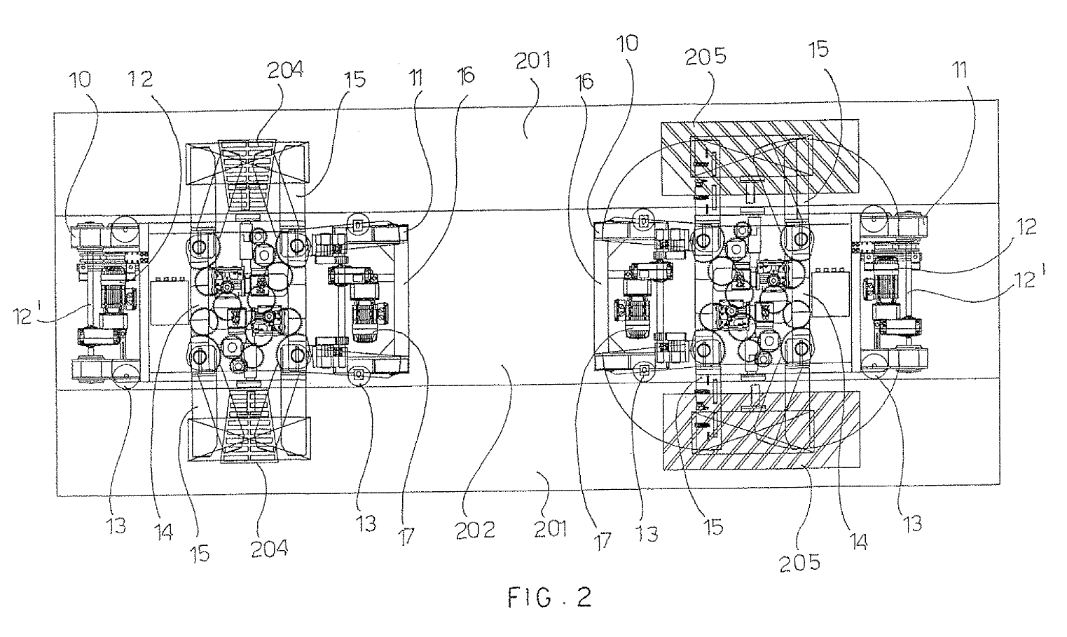

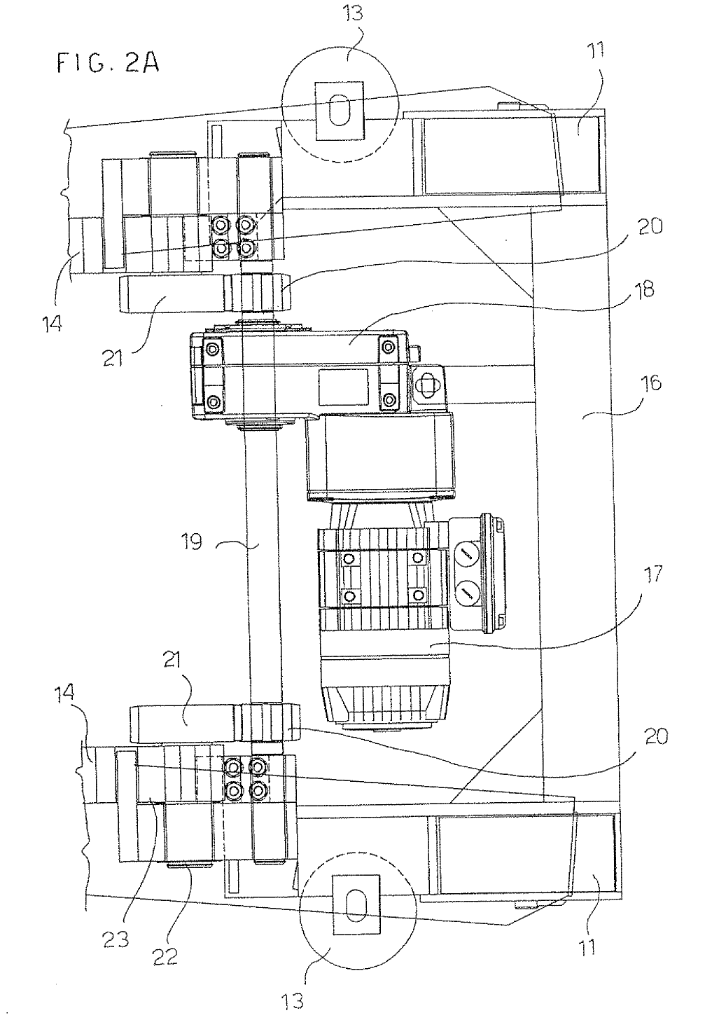

FIG. 2 is a plan view of the carriages on the platform according to FIG. 1;

FIG. 2A is an enlarged view of a detail of the front carriage according to FIG. 2;

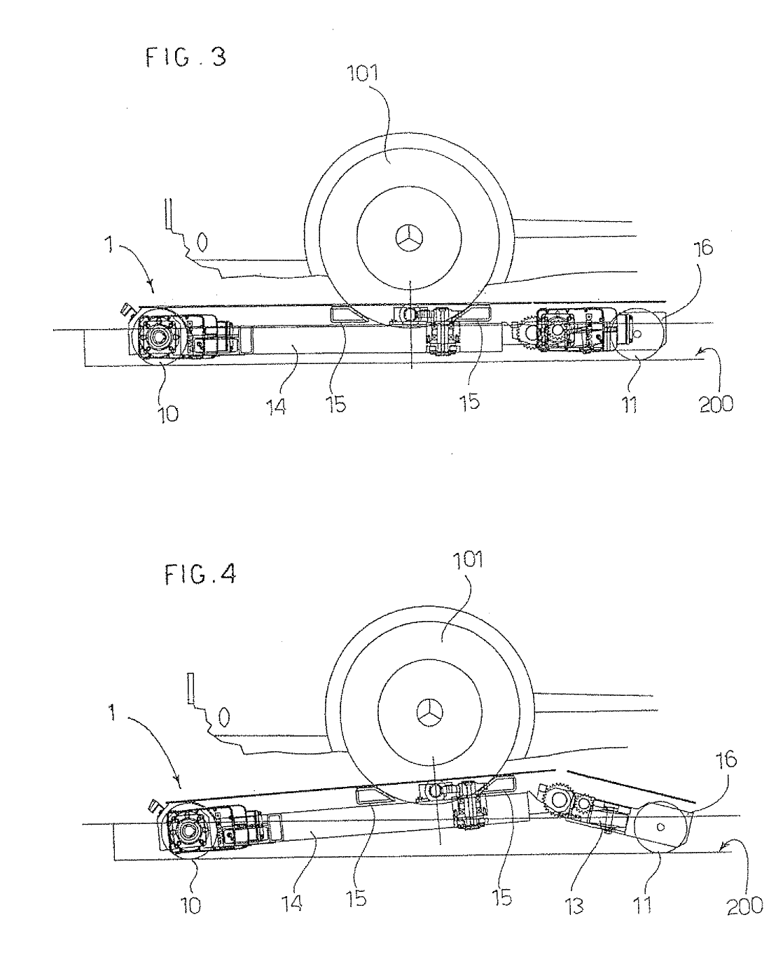

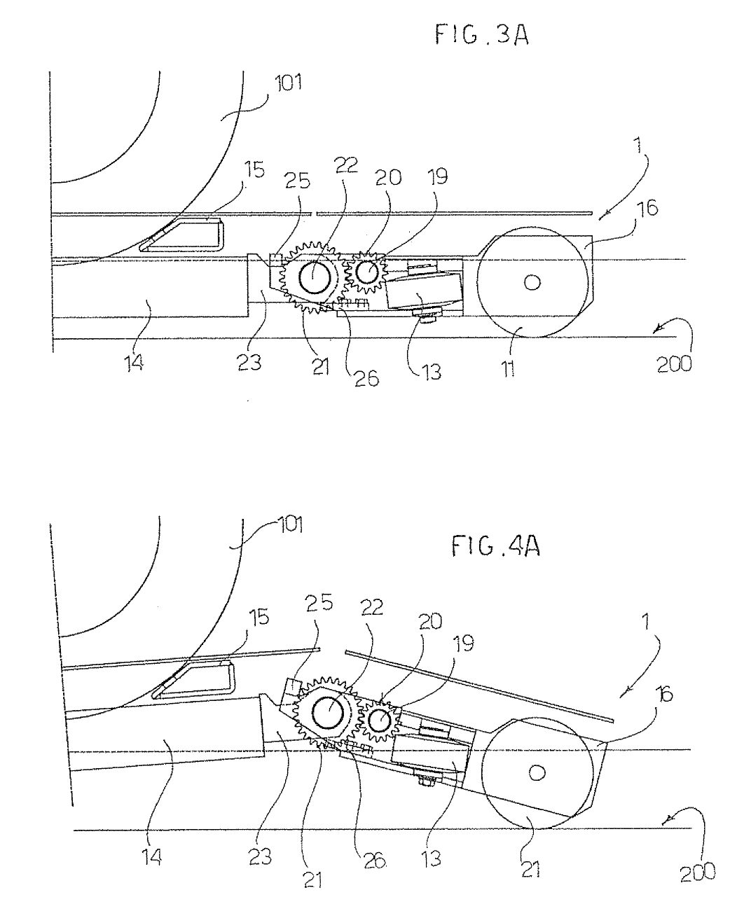

FIG. 3 is a side view of the front carriage supporting the front wheels of the car, in which the carriage is shown in the lowered position;

FIG. 3A is an enlarged view of a detail according to FIG. 3 showing the raising system in the lowered position;

FIG. 4 shows a side view as in FIG. 3, but in which the carriage is shown in the position for raising the wheels of the car; and

FIG. 4A is an enlarged view of a detail according to FIG. 4 showing the raising system in the raised position.

FIG. 1 shows a car 100 comprising a pair of front wheels 101 and a pair of rear wheels 102 which are intended to be raised and transported by a front carriage 1 and by a rear carriage 2, respectively. In FIGS. 1 and 2 the front carriage 1 and rear carriage 2 are shown on a movable platform or frame 200 in an entry/exit area of an automated multistorey car park. The platform 200 may be lowered and raised so as to position the car 100 on the floor of a bay within the multistorey car park.

As shown more clearly in FIG. 2, the platform 200 has a substantially rectangular form and comprises two lateral corridors 201 along which the wheels 101, 102 of the car 100 are able to advance and a central channel 202 inside which the front carriage 1 and the rear carriage 2 can travel. The lateral corridors 201 of the platform are provided with two front rollerways 204 and two rear rollerways 205 on which the front wheels 101 and rear wheels 102 of the car are arranged, before they are picked up by the carriages 1 and 2.

The front carriage 1 and the rear carriage 2 are substantially symmetrical and therefore identical or similar parts present in both the carriages 1 and 2 are indicated by the same reference numbers.

Each carriage 1, 2 comprises two front wheels 10 and two rear wheels 11 which roll inside special guides inside the channel 202 of the platform. The front part of the front carriage 1 is provided with a gear motor 12 which rotationally drives a shaft 12′ connected to the front wheels 10. Instead, the rear part of the rear carriage 2 is provided with a gear motor 12 which rotationally drives a shaft 12′ connected to the rear wheels 11. Each carriage 1, 2 comprises guide rollers 13 with a vertical axis which roll along the internal edges of the corridors 201.

Each carriage 1, 2 comprises a support frame 14—referred to below as main frame—in the form of a surrounding rim, on which four levers 15 able to be arranged underneath the wheels 101, 102 of the car are pivotably hinged in order to raise them. The levers 15 are able to rotate about their own fulcrum by means of a system of gears known per se. The fulcrum points of the levers 15 are arranged at the corners of a rectangle.

The levers 15, performing a rotation through about 80°-100°, are able to pass from an inactive retracted position with their axes substantially parallel to the longitudinal axis of the carriage 1, 2, into an extracted working position where they project outwards, with their axes substantially perpendicular to the longitudinal axis of the carriage and symmetrical with respect to a transverse axis of the carriage. In the working position, the bars 15 are arranged respectively underneath the wheels of the car, in contact with the tyre tread.

The main frame 14 may also support a system for centring the wheels of the car. This centring system may use the same drive as the system for actuating the bars 15 or an independent drive.

The main frame 14, in addition to supporting the system for actuating the bars 15, and the system—if present—for centring the wheels of the vehicle, rotatably supports the driving wheels of the respective carriage and the respective drive for the driving wheels.

Each carriage 1, 2 has a frame portion 16, referred to below as secondary frame 16, which is mounted so as to be hinged with respect to the main frame 14 so that the secondary frame 16 is able to rotate with respect to the main frame 14 about a transverse and horizontal axis. The secondary frame 14 is connected to the main frame 16, for example by means of hinges with pins on a transverse axis.

The non-driving (idle) wheels are rotatably mounted in the secondary frame 16, namely in the front frame 1, the front driving wheels 10 are mounted in the support frame 14 and the rear idle wheels 11 are mounted in the secondary frame 16. Instead, in the rear carriage 2, the rear driving wheels 11 are mounted in the main frame 14 and the front idle wheels 10 are mounted in the secondary frame 16.

With particular reference to FIG. 2A, the secondary frame 16 has, mounted thereon, a motor 17 for actuating the system for raising the carriage. The motor 17 has a reducer 18 which rotationally actuates a shaft 19 mounted rotatably and transversely in the secondary frame 16. The shaft 19 has, close to its ends, two pinions 20 which are keyed thereon.

As shown more clearly in FIGS. 3A and 4A, the pinions 20 mesh with respective gearwheels 21 keyed on respective shafts 22. The gearwheels 21 have a diameter which is greater (substantially twice) than the diameter of the respective pinions 20. The shafts 22 are mounted fixed in respective brackets 23 which are integral with the main frame 14. In this way the gearwheels 21 are rigidly connected to the main frame 14. Therefore the main support frame 14 is connected to the secondary frame 16 by means of a compass-joint system.

As a result, a clockwise rotation (FIGS. 3A and 4A) of the pinions 20 forces an anti-clockwise rotation of the gearwheels 21. Since the gearwheels 21 are rigidly connected to the main frame 14, the pinions 20 are mounted rotatably in the secondary frame 16 and the two frames 14 and 16 are hinged with each other, the two frames 14 and 16 tend to move towards each other by means of rolling of the wheels 11 and therefore their ends respectively supporting the gearwheels 21 and the pinions 20 are raised.

With reference to the front carriage 1, after the bars 15 have been arranged underneath the front wheels 101 of the vehicle so as to support them, the end of the main frame 14 must be raised by that amount sufficient to detach completely the wheels 101 of the vehicle from the ground. Raising by 1.5 cm the end of the main frame 14 is sufficient to allow complete separation of the wheels 101 of the vehicle from the ground.

In order to obtain raising of the main frame 14, the pinions 20 and the gearwheels 21 are formed so that a rotation of only three teeth is sufficient. Consequently the reducer 18 may be selected so as to ensure a high reduction ratio, for example so as to cause rotation of the shaft 19 at a speed of rotation of 4 revolutions per minute.

The end of the secondary frame 16 directed towards the main frame 14 has, mounted thereon, mechanical end-of-travel stops for downward movement 25 and mechanical end-of-travel stops for upward movement 26. The mechanical end-of-travel stops for downward movement 25 are arranged above the respective brackets 23 of the main frame 14. Instead the mechanical end-of-travel stops for upward movement 26 are arranged underneath the respective brackets 23 of the main frame 14.

The mechanical end-of-travel stops for downward movement 25 are mounted in a fixed manner so as to come into contact against the respective bracket 23, when the two frames 14 and 16 are lowered, namely are arranged in a horizontal frame, avoiding in this way any further lowering of the two frames 14 and 16.

Instead, the mechanical end-of-travel stops for upward movement 26 are mounted in an adjustable manner so as to come into contact against the respective bracket 23 when the two frames 14 and 16 are raised by the desired amount, namely are arranged in planes inclined with respect to the horizontal, avoiding in this way a further raising of the two frames 14 and 16. Clearly the mechanical end-of-travel stops for upward movement 26 may be adjusted so as to obtain raising of the main frame 14 by the desired height.

The present embodiment of the invention may be subject to numerous variations and modifications to details, within the reach of a person skilled in the art, but nevertheless fall within the scope of the invention defined by the accompanying claims.

1. Device for handling cars (100) in multistorey car parks, comprising a front carriage (1) able to be positioned opposite the front wheels (101) of the car so as to raise them and a rear carriage (2) able to be positioned opposite the rear wheels (102) of the car so as to raise them, in such a way as to be able to move the car (100), each carriage (1, 2) comprising a main frame (14) supporting gripping means (15) able to support the wheels (101, 102) of the car,
characterized in that
at least one of said carriages comprises a secondary-frame (16) pivotably mounted, along a transverse axis, on said main frame (14),
in which said secondary frame (16) is joined to said main frame (14) in a compass-joint relationship by means of respective pinions (20) and gearwheels (21) which mesh with each other and which are rotationally actuated by means of a drive (17) so as to obtain raising/lowering of the main frame (14).

2. Device according to claim 1, characterized in that the drive wheels of the carriage are mounted in said main frame (14) and the idle wheels of the carriage are mounted in said secondary frame (16).

3. Device according to claim 1, characterized in that said drive (17) of the raising system comprises an electric motor (17) which is mounted on the secondary frame (16) and connected to a reducer (18) which rotationally actuates a shaft (19) mounted transversely and rotatably on the second frame (16), said shaft (19) supporting two pinions (20) which mesh with respective gearwheels (21) rigidly connected to the main frame (14).

4. Device according to claim 3, characterized in that said gearwheels (21) of the main frame have a diameter which is greater than that of the pinions (20) of the secondary frame.

5. Device according to claim 3, characterized in that said gear motor (18) is selected so as to impart to said shaft (19) of the secondary frame a rotation of about 4 revolutions per minute.

6. Device according to claim 3, characterized in that said pinions (20) and said gearwheels (21) are selected so as to impart a raising movement of about 1.5 cm of the main frame for a rotation of about 3 teeth.

7. Device according to claim 1, characterized in that it comprises end-of-travel stops for downward movement (25) for stopping lowering of said main frame and secondary frame (14, 16) in a position where they are parallel to the horizontal plane.

8. Device according to claim 7, characterized in that said end-of-travel means for downward movement (25) comprise at least one mechanical stop (25) integral with the secondary frame (16) and directed towards the main frame (14) so as to come into contact against a respective bracket (23) of the main frame.

9. Device according to claim 1, characterized in that it comprises end-of-travel means for upward movement (26) for stopping raising of said main and secondary frame (14, 16) in a preset maximum raised position.

10. Device according to claim 9, characterized in that said end-of-travel means for upward movement (26) comprise at least one mechanical stop (26) integral with the secondary frame (16) and directed towards the main frame (14) so as to come into contact against a respective bracket (23) of the main frame.

11. Carriage (1, 2) for handling cars (100) in automated multistorey car parks, comprising a main frame (14) supporting gripping means (15) able to support the wheels (101, 102) of the car, characterized in that it also comprises a secondary frame (16) pivotably mounted, along a transverse axis, on said main frame (14), in which said secondary frame (16) is joined to said main frame (14) in a compass-joint relationship by means of respective pinions (20) and gearwheels (21) which mesh with each other and which can be rotationally actuated by means of a drive (17) so as to obtain raising/lowering of the main frame (14).

12. Device according to claim 2, characterized in that the drive wheels of the carriage are mounted in said main frame (14) and the idle wheels of the carriage are mounted in said secondary frame (16).

13. Device according to claim 4, characterized in that said gear motor (18) is selected so as to impart to said shaft (19) of the secondary frame a rotation of about 4 revolutions per minute.
